(19) United States
(12) Patent Application Publication
(10) Pub. No.: US 2026/0100990 A1
(43) Pub. Date: Apr. 9, 2026

(54) LATENCY BASED CIRCUIT BREAKER FOR A SERVICE PROCESS

(71) Applicant: Charter Communications Operating, LLC, St. Louis, MO (US)

(72) Inventor: Jeffrey Scott Gillings, Lakewood, CO (US)

(21) Appl. No.: 18/910,895

(22) Filed: Oct. 9, 2024

(51) Int. Cl. H04L 67/562

(52) U.S. Cl. CPC H04L 67/562

(57) ABSTRACT

A plurality of request latencies for a service process are determined. A proxy process receives a request destined for the service process. The proxy process determines that a state of a circuit breaker associated with the service process is a closed state such that the request can be sent to the service process. The proxy process sends the request to the service process. The proxy process determines a request latency of the request. The proxy process stores the request latency of the plurality of request latencies in a data structure. This process is repeated for a plurality of requests. Responsive to determining, based on the data structure, that an unfavorable request latency condition exists, setting the state of the first circuit breaker to an opened state, such that subsequent requests received by the proxy process cannot be sent to the service process.

### BACKGROUND

Complex applications are increasingly designed and developed in discrete units, such as micro-services, that communicate with one another to collectively implement a desired function, such as an online web store, or an accounting system. Distributing pieces of functionality of the application across multiple services facilitates scalability and simplifies subsequent maintenance and feature enhancement.

### SUMMARY

The examples disclosed herein implement a latency based circuit breaker for a service process.

In one implementation a method is provided. The method includes determining a plurality of request latencies for a service process by, for each of a plurality of iterations: receiving, by a proxy process, a request destined for the service process; determining, by the proxy process, that a state of a first circuit breaker associated with the service process is a closed state such that the request can be sent to the service process; and sending, by the proxy process, the request to the service process; storing, by the proxy process, a request latency of the plurality of request latencies in a data structure, wherein the request latency is representative of a period of time that elapsed between sending the request to the service process and determining that the service process has generated a response to the request. The method further includes, responsive to determining, based on the data structure, that an unfavorable request latency condition exists, setting the state of the first circuit breaker to an opened state, such that subsequent requests received by the proxy process cannot be sent to the service process.

In another implementation a computing device is provided. The computing device includes a memory, and one or more processor devices coupled to the memory operable to determine a plurality of request latencies for a service process by, for each of a plurality of iterations: receiving, by a proxy process, a request destined for the service process; determining, by the proxy process, that a state of a first circuit breaker associated with the service process is a closed state such that the request can be sent to the service process; sending, by the proxy process, the request to the service process; and storing, by the proxy process, a request latency of the plurality of request latencies in a data structure, wherein the request latency is representative of a period of time that elapsed between sending the request to the service process and determining that the service process has generated a response to the request. Responsive to determining, based on the data structure, that an unfavorable request latency condition exists, the one or more processor devices are further operable to set the state of the first circuit breaker to an opened state, such that subsequent requests received by the proxy process cannot be sent to the service process.

In another implementation a non-transitory computer-readable storage medium is provided. The non-transitory computer-readable storage medium includes executable instructions operable to cause one or more processor devices to determine a plurality of request latencies for a service process by, for each of a plurality of iterations: receiving, by a proxy process, a request destined for the service process; determining, by the proxy process, that a state of a first circuit breaker associated with the service process is a closed state such that the request can be sent to the service process; sending, by the proxy process, the request to the service process; and storing, by the proxy process, a request latency of the plurality of request latencies in a data structure, wherein the request latency is representative of a period of time that elapsed between sending the request to the service process and determining that the service process has generated a response to the request. Responsive to determining, based on the data structure, that an unfavorable request latency condition exists, the instructions are further operable to cause the one or more processor devices to set the state of the first circuit breaker to an opened state, such that subsequent requests received by the proxy process cannot be sent to the service process.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram illustrating a latency based circuit breaker for a service process according to some implementations;

FIG. 2 is a flowchart of a method for utilizing a latency based circuit breaker for a service process according to some implementations; and

FIG. 3 is a block diagram of a computing device suitable for implementing a latency based circuit breaker for a service process according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Complex applications are increasingly designed and developed in discrete units, such as micro-services, that communicate with one another to collectively implement a desired function, such as an online web store, or an accounting system. Distributing pieces of functionality of the application across multiple services facilitates scalability and simplifies subsequent maintenance and feature enhancement.

A service in a distributed system that receives a request, or synonymously as used herein, a message, from a requestor (such as an end user device or a downstream service) for processing may need to interact with one or more upstream services to obtain information necessary to respond to the request. Any such upstream service may also need to interact with another upstream service, and thus, the processing time for a service to generate a response to a request may in fact be dependent on processing times of one or more upstream services.

A circuit breaker is a function that may be used to control the flow of requests to a service. If the circuit breaker is closed, the service will be provided additional requests. If the circuit breaker is open, the service will not be provided additional requests. Conventional circuit breakers are relatively simplistic and are typically based on counters, such as a total number of active connections, or the like. Once a threshold number of connections between the service and multiple requestors is met, the circuit breaker is opened, and subsequent connections are denied.

In practice poor responsiveness of a service may be relatively or completely unrelated to the number of requestors that have connected with a service. Poor responsiveness may be related to issues with upstream services, issues with connections between upstream services, temporary computer resource limitations of the device on which the service is running, or myriad other factors that may be somewhat temporary in nature. During a time of poor responsiveness it may be desirable to open a circuit breaker associated with the service such that subsequent requests are not provided to the service. The circuit breaker may subsequently be closed again after a predetermined period of time has passed or some other condition is met.

The examples disclosed herein implement a latency based circuit breaker for a service (referred to herein as a “service process” to distinguish from a proxy process). In particular, a plurality of request latencies for a service process are determined. A proxy process associated with the service process receives a request destined for the service process. The proxy process sends the request to the service process. Subsequently the proxy process determines that the service process has generated a response to the request and determines a request latency representative of a period of time that elapsed between sending the request to the service process and determining that the service process has generated the response to the request. The proxy process stores the request latency in a data structure. This process may be repeated for any number of requests. Intermittently, periodically or in response to some event the proxy process may determine, based on the request latencies stored in the data structure, that an unfavorable request latency condition exists. For example, if an average request latency over a predetermined period of time exceeds a threshold value it may be determined that an unfavorable request latency condition exists. In response, the proxy process may set the state of a circuit breaker associated with the service process to an opened state such that subsequent requests received by the proxy process cannot be sent to the service process.

The proxy process may, after a predetermined period of time, subsequently set the circuit breaker associated with the service process to a closed state such that subsequent requests received by the proxy process can be sent to the service process. The proxy process may then repeat the process above to determine whether the unfavorable request latency condition still exists or recurs. In this manner, the examples disclosed herein implement a dynamic circuit breaker for a service process that corresponds to actual real-time responsiveness, in terms of latency, of the service process.

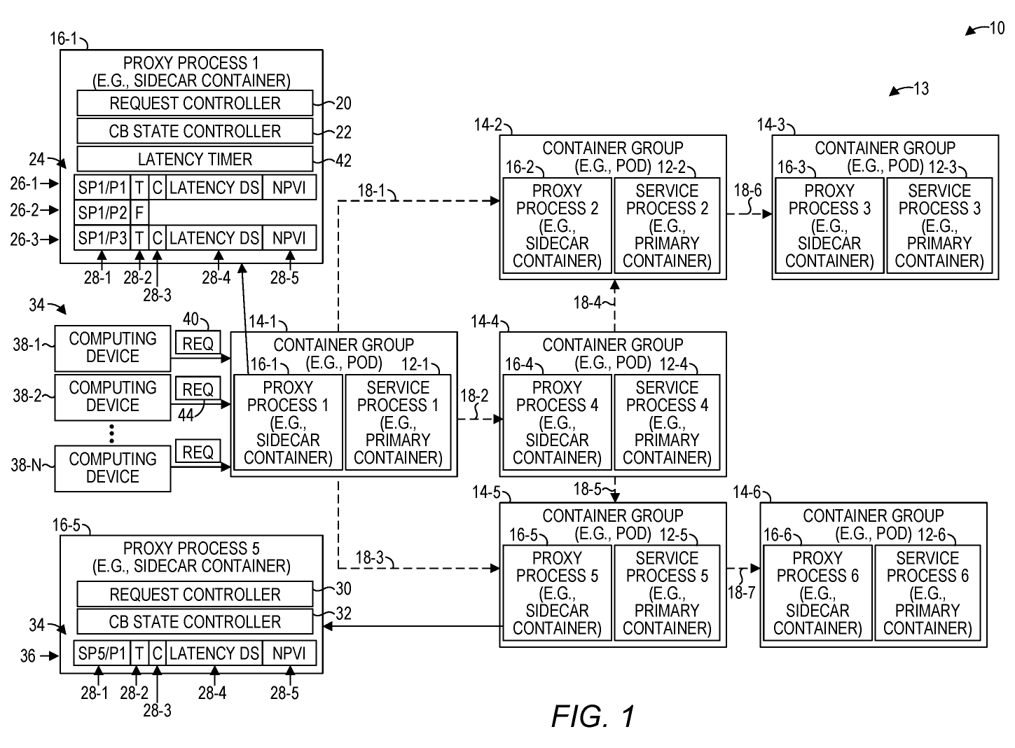

FIG. 1 is a block diagram of an environment 10 in which a latency based circuit breaker for a service process may be practiced according to some implementations. The environment 10 includes a plurality of interrelated service processes 12-1 – 12-6 (generally, service processes 12) that implement an application 13 which provides some desired functionality, such as, by way of non-limiting example, an online web store. The term “service process” as used herein refers to a discrete executing unit that implements a desired function and communicates with other service processes via some inter-process communication (IPC) mechanism. The interrelated service processes 12 are implemented, in this example, as containers, but the examples are not limited to any particular implementation of service processes. The term “container” as used herein refers to a running instance of a container image that is initiated by a container runtime, such as CRI-O or containerd. The phrase “container image” as used herein refers to a static package of software comprising one or more layers, the layers including everything needed to run an application (i.e., as a container) that is initiated from the container image, including, for example, one or more of executable runtime code, system tools, system libraries and configuration settings. A Docker® image is an example of a container image.

In this example the service processes 12 are managed by a cluster-based container orchestration system such as Kubernetes, available at Kubernetes.io, that implements containers via a container group, referred to as a pod. A container group can comprise one or more containers. A container group is defined by a container group specification (referred to in Kubernetes as a “Pod manifest” or a “Pod specification”). A container group specification may identify one or more container images that are to be scheduled and executed as part of the container group. A container associated with a container group may be referred to herein as running or executing “in” the container group. A container running in the container group is said to correspond to the container group.

In this example there are six container groups 14-1 – 14-6 (generally, container groups 14), in which the service processes 12-1 – 12-6 execute, respectively. Each container group 14-1 -14-6 also includes a corresponding sidecar proxy container, referred to herein as proxy processes 16-1 – 16-6 (generally, proxy processes 16). The proxy processes 16 operate to receive requests directed to the corresponding service process 12 and implement certain functionality as described in greater detail below. The existence of the proxy processes 16 may be transparent to the service processes 12. In some implementations, each proxy process 16 during initiation may perform network operations such that requests directed to the corresponding service process 12 are instead delivered to the proxy process 16. For example, the proxy process 16-1, when initiated, may modify IP tables associated with the container group 14-1 such that any requests directed to the IP address (or URL path) associated with the service process 12-1 are instead delivered to the proxy process 16-1. The proxy process 16-1 may then, as will be described in greater detail below, decide to send the request to the service process 12-1 or decide to reject the request.

The term “request” as used herein refers to any type of communication that may be sent to a service process 12. In some implementations, the requests comprise HTTP requests, such as GET, POST, PUT, PATCH, and DELETE requests, although the examples disclosed herein are not limited to any particular type of request.

In some implementations the container groups 14 may be part of a service mesh and communicate via a service mesh infrastructure, such as an Istio service mesh infrastructure (www.istio.io), although the examples disclosed herein are not limited to any particular service mesh architecture, or indeed to service meshes.

The service processes 12 communicate with one another using any desired inter-process communication (IPC) mechanism, such as, by way of non-limiting examples, one or more of message queues, files, a RESTful API, service mesh IPC mechanisms, and the like. In some implementations each of the service processes 12 have their own IP address and communicate with each other by sending requests to the IP address (or URL path) of the service process 12 with which they want to communicate.

While not illustrated due to space limitations, each of the container groups 14 run (e.g., execute) on a computing device that includes memory and one or more processor devices. The container groups 14 may execute on the same computing device, or may execute on multiple computing devices. In a cloud computing environment, the container groups 14 may be distributed over any number of computing devices.

One service process 12 may be referred to as being upstream or downstream with respect to another service process 12. A first service process 12 that receives a message from a second service process 12 may be referred to as being upstream from the second service process 12. In response to receiving a message from the second service process 12 the first service process 12 may send a message to a third service process 12. In that situation, the first service process 12 may be referred to as being downstream from the third service process 12.

FIG. 1 illustrates potential communications between the service processes 12 suitable for implementing the functionality of the application 13. For example, a dashed communication path 18-1 indicates that the service process 12-1 may send a message to the service process 12-2. A dashed communication path 18-2 indicates that the service process 12-1 may send a message to the service process 12-4. A dashed communication path 18-3 indicates that the service process 12-1 may send a message to the service process 12-5. The different potential communication paths may correspond to different actions that the service process 12-1 takes based on the content of a request received by the service process 12-1.

Similarly, a dashed communication path 18-4 indicates that the service process 12-4 may send a message to the service process 12-2. A dashed communication path 18-5 indicates that the service process 12-4 may send a message to the service process 12-5. A dashed communication path 18-6 indicates that the service process 12-2 may send a message to the service process 12-3 and a dashed communication path 18-7 indicates that the service process 12-5 may send a message to the service process 12-6.

It is noted that for purposes of illustration the application 13 illustrated herein is a relatively simple application and in practice the application 13 may have hundreds of different service processes 12 that communicate with each other via hundreds or thousands of different potential communication paths 18.

The proxy process 16-1 may include a request controller 20 and a circuit breaker (CB) state controller 22. As will be described in greater detail herein, the request controller 20 is responsible for determining a current state of a circuit breaker, forwarding or rejecting requests based on such current state, and determining and storing request latencies. As will also be described in greater detail herein, the CB state controller 22 is responsible for periodically, intermittently, and/or in response to some event, analyzing request latencies and determining whether to alter the state of a circuit breaker.

The state of a circuit breaker will be referred to herein as “open” or “closed”. When in a closed state a proxy process 16 will deliver requests to the corresponding service process 12, and when in the open state the proxy process 16 will not deliver requests to the corresponding service process 12 and may send a response, such as an HTTP 429 or 529 code or other suitable response to indicate to the requestor that the request has been rejected.

A service process 12 may receive requests via one or more URL paths, and each URL path may be associated with a circuit breaker, or not. The path via which a service process 12 receives a request may determine what processing is applied to the request, or may correspond to a priority, may otherwise cause the service process 12 to implement certain functionality, or may simply be a load balancing mechanism.

In this example a data structure 24 contains three entries 26-1 – 26-3. The data structure 24 may be maintained in a configuration file accessed by the proxy process 16-1 during initialization. A field 28-1 identifies the URL path associated with the particular entry 26, a circuit breaker indicator field 28-2 identifies whether the URL path has an associated (or corresponding) circuit breaker (“T” means yes and “F” means no), and a field 28-3 indicates the current state of the circuit breaker (“C” means closed such that requests are delivered to the service process 12-1 and “O” means open such that requests are not delivered to the service process 12-1). The “circuit breaker” is functionality implemented by the proxy process 16-1 based on the values of the circuit breaker indicator field 28-2 and the field 28-3. If the circuit breaker indicator field 28-2 of an entry 26 is T then the corresponding path is said to have an associated circuit breaker. If the circuit breaker indicator field 28-2 of an entry 26 is F then the corresponding path is said to not have an associated circuit breaker. If the path has an associated circuit breaker, then the field 28-3 indicates whether the circuit breaker is open, such that requests will not be sent to the service 12-1 or closed, such that requests will be sent to the service 12-1.

A field 28-4 represents another data structure in which request latencies may be maintained, and a field 28-5 contains non-preferred value information (NPVI) from which the CB state controller 22 can determine, in conjunction with the request latencies, whether a change in state of a circuit breaker is appropriate. Each URL path may have different non-preferred value information such that a particular condition may cause a circuit breaker on one path to be closed but the same condition on another URL path may cause a circuit breaker associated with the URL path to be open.

In this example, the entry 26-1 corresponds to a path “SP1/P1”, the path “SP1/P1” has a circuit breaker, and the current state of the circuit breaker is closed. The entry 26-2 corresponds to a path “SP1/P2”, the path “SP1/P2” does not have a circuit breaker. The entry 26-3 corresponds to a path “SP1/P3”, the path “SP1/P3” has a circuit breaker, and the current state of the circuit breaker is closed.

It is noted that the data structure 24 is only one example of implementing aspects of the embodiments disclosed herein, but any implementation from which the information above can be derived may be used. As another example implementation, if a path lacks a circuit breaker, the data structure 24 may simply omit that path from the data structure 24. The lack of an entry 26 that corresponds to a path constitutes a circuit breaker indicator that indicates that the path does not have a corresponding circuit breaker.

The proxy processes 16-2 – 16-6 may implement similar or identical functionality as described herein for the proxy process 16-1, but each proxy process 16 may monitor a different number of URL paths, and different non-preferred value information. For example, the proxy process 16-5 includes a request controller 30 that operates similarly to the request controller 20, and a circuit breaker state controller 32 that operates similarly to the circuit breaker state controller 22. The proxy process 16-5 includes a data structure 34 that includes an entry 36. The entry 36 indicates that the service process 12-5 processes requests via a single path “SP5/P1”, which has a circuit breaker which is currently in the closed state.

With this background examples of a latency based circuit breaker for a service process will be discussed. In this example the service process 12-1 may be an entry point into the application 13 such that all requests made to the application 13 are first processed by the service process 12-1. Thus, in this example, requestors comprise one or more user computing devices 38-1 – 38-N (generally, computing devices 38). However it is noted that the discussion herein with respect to the proxy process 16-1 is equally applicable to the proxy processes 16-2 – 16-6, although the requestors for such corresponding services 12-2 – 12-6 are downstream services 12 rather than end-user computing devices 38. For example, with regard to the service process 12-5, a requestor may be the service process 12-1, as indicated by the communication path 18-3 or the service process 12-4, as indicated by the communication path 18-5.

The computing device 38-1 sends a request 40 to the service process 12-1. The proxy process 16-1 intercepts the request 40 such that the request 40 is not delivered to the service process 12-1. As discussed above, any suitable interception mechanism may be used by the proxy process 16-1, including, by way of non-limiting example, modifying IP tables of the container group 14-1 to cause requests directed to the IP address of the service process 12-1 to be delivered instead to the proxy process 16-1.

The request controller 20 of the proxy process 16-1 receives the request 40 and determines that the request identifies the URL path “SP1/P1”. The request controller 20 determines that the entry 26-1 corresponds to the URL path “SP1/P1”. The request controller 20 accesses the circuit breaker indicator field 28-2 of the entry 26-1 and determines that this path has a circuit breaker. The request controller 20 accesses the field 28-3 of the entry 26-1 and determines that the circuit breaker is closed. In response to determining that the circuit breaker is closed, the request controller 20 starts a latency timer 42. The request controller 20 sends the request 40 to the service process 12-1. The service process 12-1 receives the request 40 and processes the request 40. The processing may involve sending one or more subsequent requests to upstream service processes 12, such as one or more of the service processes 12-2, 12-4 and/or 12-5. In turn, an upstream service process 12 that receives such request may in the course of processing the request generate another request and send the request to another upstream service process 12. Each such request may result in a corresponding response and ultimately the service process 12-1 generates a response to the request 40. In this example assume for purposes of illustration that the service process 12-1, based on the request 40, sends a request to the service 12-2. The service process 12-1 receives a response from the service process 12-2 and generates a response based on the upstream service response.

The request controller 20 determines that the service process 12-1 has generated a response to the request 40. In some implementations the service process 12-1 sends the response to the sender of the request 40, which is the proxy process 16-1. The request controller 20 stops the timer 42. The elapsed time of the timer 42 is a request latency that is representative of a period of time that elapsed between sending the request 40 to the service process 12-1 and determining that the service process 12-1 has generated the response to the request 40. The request controller 20 may send the response to the computing device 38-1.

The request controller 20 stores the request latency in the data structure identified in the field 28-4 of the entry 26-1. The data structure may be in any suitable format, such as a linked list, a database, or the like. The request controller 20 may also store a timestamp in conjunction with the request latency so that the request controller 20 can subsequently determine how long ago each request latency was determined. In some implementations the data structure may comprise a probabilistic digest, such as a t-digest, that estimates percentiles and other values while requiring a relatively small amount of storage. The request controller 20 may repeat this process for any number of subsequent requests received from the computing devices 38-1 – 38-N. The data structure may only store a particular number of request latencies, such as the most recent fifty request latencies, the most recent one hundred request latencies, or any suitable number.

Periodically, intermittently, or upon the occurrence of some event, the CB state controller 22 analyzes the data structures identified in the fields 28-4 of the entries 26-1 and 26-3. The period may be configurable. As an example, the CB state controller 22 may access the data structure identified in the field 28-4 of the entry 26-1. The CB state controller 22 may access the non-preferred value information (NPVI) field 28-5 to obtain non-preferred value information associated with the entry 26-1. The non-preferred value information may identify both an algorithm and thresholds and/or ranges that quantify an unfavorable request latency condition. For example, the non-preferred value information may indicate a calculated request latency comprising an average (or mean) request latency is to be determined based on the request latencies stored in the data structure identified in the field 28-4. The non-preferred value information may or may not limit the average to request latencies generated within some previous period of time, such as the last minute, last two minutes, or the like. The non-preferred value information may also identify a threshold latency value, such as, by way of non-limiting information 200 milliseconds (ms), 400 ms, or the like. If the calculated request latency is above any threshold latency value, an unfavorable request latency condition exists.

As another example, the non-preferred value information may indicate that the 50th, 90th, and 95^{th} percentiles for the request latencies are to be determined. The non-preferred value information may indicate for each percentile a threshold latency, such as, by way of non-limiting example, for the 50^{th} percentile, a latency of 200ms; for the 90^{th} percentile, a latency of 500ms; and for the 95^{th} percentile, a latency of 1000ms. If the request latencies at such percentiles exceed the corresponding threshold, then an unfavorable request latency condition exists.

If the CB state controller 22 determines that an unfavorable request latency condition exists, the CB state controller 22 sets the state of the associated circuit breaker to an open state by, for example, changing the value of the field 28-3 to O (or otherwise setting the field 28-3 to a value that is understood to mean open, such as a binary 0 or 1). If the CB state controller 22 determines that an unfavorable request latency condition does not exist, the CB state controller 22 maintains the value of the field 28-3 to indicate that the circuit breaker is closed. In either situation, the CB state controller 22 may delete the request latencies from the data structure identified in the field 28-4.

The CB state controller 22 may also access the data structure identified in the field 28-4 of the entry 26-3. The CB state controller 22 may access the non-preferred value information (NPVI) field 28-5 of the entry 26-3 to obtain non-preferred value information associated with the entry 26-3. Note that the non-preferred value information may be the same or different from the non-preferred value information in the field 28-5 of the entry 26-1. Again, if the CB state controller 22 determines that an unfavorable request latency condition exists, the CB state controller 22 sets the state of the associated circuit breaker to an open state by, for example, changing the value of the field 28-3 of the entry 26-3 to O (or otherwise setting the field 28-3 to a value that is understood to mean open, such as a binary 0 or 1). If the CB state controller 22 determines that an unfavorable request latency condition does not exist, the CB state controller 22 maintains the value of the field 28-3 of the entry 26-3 to indicate that the circuit breaker is closed. In either situation, the CB state controller 22 may delete the request latencies from the data structure identified in the field 28-4 of the entry 26-3.

For purposes of illustration, assume that the CB state controller 22 determines, for the entry 26-1 (e.g., the URL path “SP1/P1”), that an unfavorable request latency condition exists. The CB state controller 22 sets the state of the associated circuit breaker to an open state by, for example, changing the value of the field 28-3 to O. Subsequently, the computing device 38-2 sends a request 44 to the service process 12-1. The proxy process 16-1 intercepts the request 44 such that the request 44 is not delivered to the service process 12-1. The request controller 20 of the proxy process 16-1 receives the request 44 and determines that the request identifies the URL path “SP1/P1”. The request controller 20 determines that the entry 26-1 corresponds to the URL path “SP1/P1”. The request controller 20 accesses the circuit breaker indicator field 28-2 of the entry 26-1 and determines that this path has an associated circuit breaker. The request controller 20 accesses the field 28-3 of the entry 26-1 and determines that the circuit breaker is open. In response to determining that the circuit breaker is open, the request controller 20 sends a request rejected indication to the computing device 38-2 to indicate that the request will not be delivered to the service process 12-1. Any suitable message may be sent. In some implementations, an HTTP 429 or 529 message may be sent. The request controller 20 inhibits sending the message 44 to the service process 12-1.

The CB state controller 22 may subsequently set the state of the associated circuit breaker to the closed state by, for example, changing the value of the field 28-3 of the entry 26-1 to a value of “C”, to allow the service process 12-1 to again begin processing requests. The CB state controller 22 may change the state after a predetermined period of time, such as 10 seconds, 15 seconds, one minute, or any other desirable period of time. The period of time may be operator configurable and may be maintained, for example, in additional field of the entry 26-1.

In some implementations, the CB state controller 22 may increase the open time of a circuit breaker based on the number of times the circuit breaker has been opened before. In one implementation, two variables may be maintained for the entry 26-1, a Cb_open_ms variable that identifies an initial period of time to keep the circuit breaker open, such as, for example, 5 seconds. A cb_consecutive_reset_ms variable identifies an amount of time after the circuit breaker closes, to reset the consecutive_counter to 1. In this example, the amount of time will be 30 seconds, and thus, if the circuit breaker is not opened for a period of 30 seconds, the consecutive_counter is reset. When the circuit breaker is initially opened, the CB state controller 22 multiplies the Cb_open_ms variable (5 seconds) and the consecutive_counter (1) to determine a product of 5 seconds. The CB state controller 22 sets the state of the circuit breaker to open and sets a first timer for 5 seconds. The CB state controller 22 increments the consecutive_counter to a value of two. After the first timer elapses, the CB state controller 22 sets the state of the circuit breaker to closed.

Subsequently, the CB state controller 22 determines that an unfavorable request latency condition exists again. The CB state controller 22 multiplies the Cb_open_ms variable (5 seconds) and the consecutive_counter (2) to determine a product of 10 seconds. The CB state controller 22 sets the state of the circuit breaker to open and sets a timer for 10 seconds. The CB state controller 22 increments the consecutive_counter to a value of three. This process may continue. However, each time the CB state controller 22 closes the circuit breaker, the CB state controller 22 sets a second timer to the value of the Cb_consecutive_reset_ms variable, thirty seconds. If the second timer elapses, indicating that the circuit breaker remained closed for 30 seconds, the CB state controller 22 resets the consecutive_counter to a value of 1.

In another implementation the CB state controller 22 and the request controller 20 operate in conjunction to open and close the circuit breaker such that a certain percentage of requests are rejected over a period of time. In this example, when an unfavorable request latency condition exists a rejection_factor may be determined, wherein the rejection_factor = (1-(actual_latency / threshold-latency)) * rejection_modifier (default 0.5). For example, (1-( 4500ms / 3000ms)) * .5 = 0.25. Thus, in this example, 25% of the requests will be rejected. The rate of requests over a time period can be determined by analyzing the request latencies and the corresponding timestamps in the data structure. The rate of requests are scaled to a time period (e.g., such as 1 second) and the first N requests in each second are rejected, wherein N = rejection_factor * calculated rate per second. Assume that the calculated rate is 50 requests per second. In this example, the circuit breaker will be open such that the first 13 requests are rejected each second, and then closed such that the remainder of the requests for each second are sent to the service process 12-1.

It is noted that, because the CB state controller 22 and the request controller 20 are components of a computing device, functionality implemented by the CB state controller 22 or the request controller 20 may be attributed to the computing device generally. Moreover, in examples where the CB state controller 22 and the request controller 20 comprises software instructions that program a processor device to carry out functionality discussed herein, functionality implemented by the CB state controller 22 and the request controller 20 may be attributed herein to such processor device.

It is further noted that while the CB state controller 22 and the request controller 20 are shown as separate components, in other implementations, the CB state controller 22 and the request controller 20 could be implemented in a single component or could be implemented in a greater number of components than two.

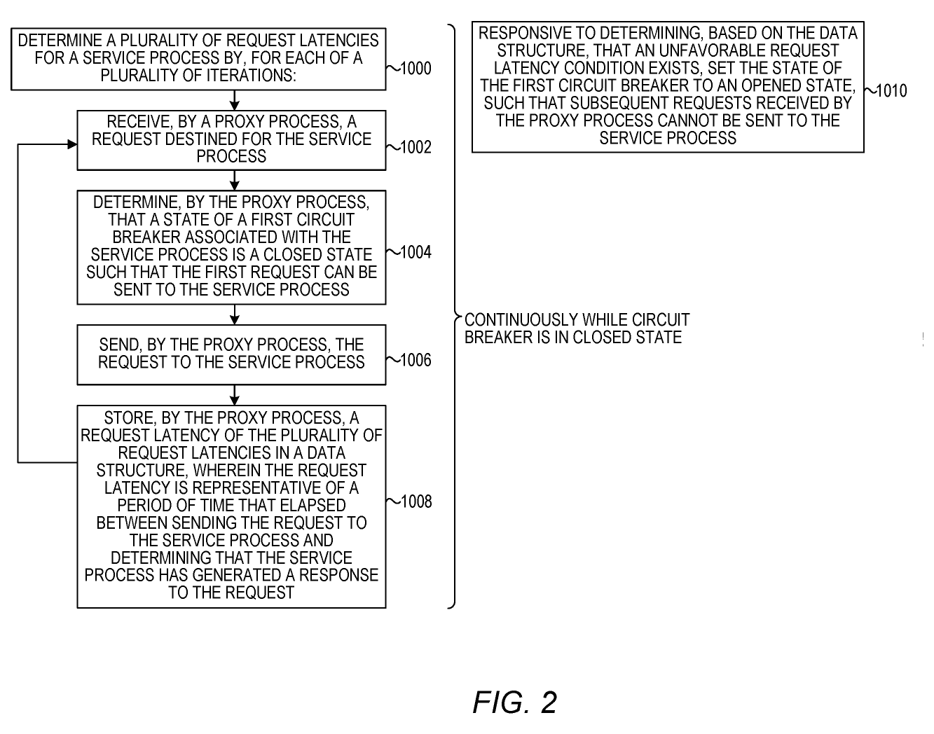

FIG. 2 is a flowchart of a method for utilizing a latency based circuit breaker for a service process according to some implementations. FIG. 2 will be discussed in conjunction with FIG. 1. The proxy process 16-1 determines a plurality of request latencies for the service process 12-1 (FIG. 2, block 1000). The proxy process 16-1 receives a request destined for the service process 16-1 (FIG. 2, block 1002). The proxy process 16-1 determines that a state of the circuit breaker associated with the service process 12-1 is a closed state such that the request can be sent to the service process 12-1 (FIG. 2, block 1004). The proxy process 16-1 sends the request to the service process 12-1 (FIG. 2, block 1006). The proxy process 16-1 determines that the service process 12-1 has generated a response to the request. The proxy process 16-1 stores a request latency of the plurality of request latencies in the data structure referenced in the field 28-4, wherein the request latency is representative of a period of time that elapsed between sending the request to the service process 12-1 and determining that the service process 12-1 has generated the response to the request (FIG. 2, block 1008). This process continues while the circuit breaker is in the closed state.

Periodically, intermittently, or in response to some event, the proxy process 16-1 analyzes and may determine, based on the data structure referenced in the field 28-4, that an unfavorable request latency condition exists. In response, the proxy process 16-1 sets the state of the circuit breaker to an opened state, such that subsequent requests received by the proxy process 16-1 cannot be sent to the service process 12-1 (FIG. 2, block 1010).

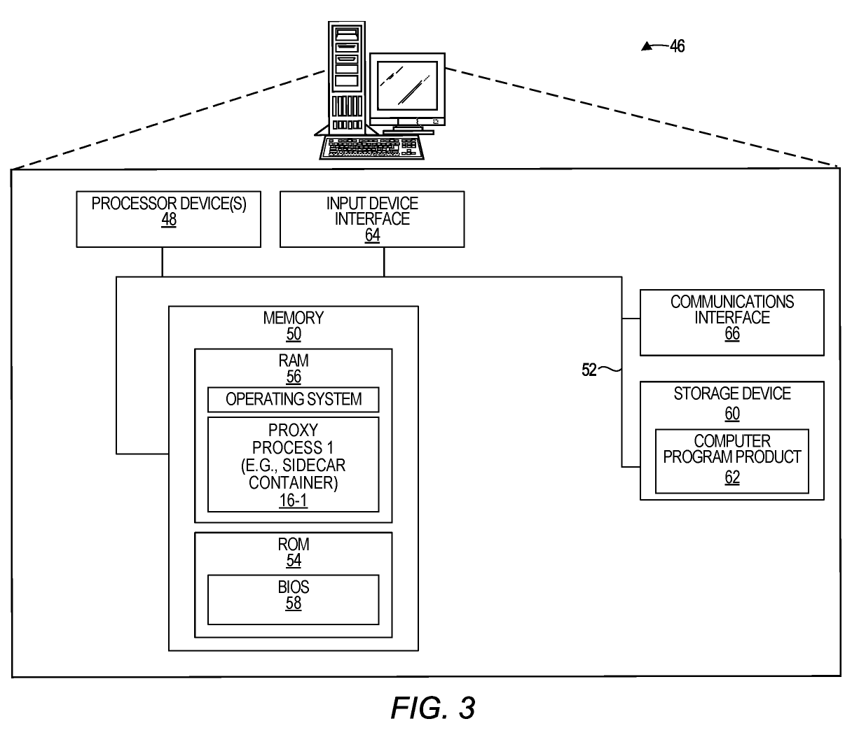

FIG. 3 is a block diagram of a computing device 46 suitable for implementing examples disclosed herein. The computing device 46 may comprise any computing or electronic device capable of including firmware, hardware, and/or executing software instructions to implement the functionality described herein, such as a computer server, a desktop computing device, or the like. The computing device 46 includes one or more processor devices 48, a system memory 50, and a system bus 52. The system bus 52 provides an interface for system components including, but not limited to, the system memory 50 and the processor device 48. The processor device 48 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The system memory 50 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the computing device 46. The volatile memory 56 may also include a high-speed RAM, such as static RAM, for caching data.

The computing device 46 may further include or be coupled to a non-transitory computer-readable storage medium such as a storage device 60, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 60 and other drives associated with computer-readable media and computer-usable media may provide non-volatile storage of data, data structures, computer-executable instructions, and the like.

A number of modules can be stored in the storage device 60 and in the volatile memory 56, including an operating system and one or more program modules, such as the proxy process 16-1, which may implement the functionality described herein in whole or in part. All or a portion of the examples may be implemented as a computer program product 62 stored on a transitory or non-transitory computer-usable or computer-readable storage medium, such as the storage device 60, which includes complex programming instructions, such as complex computer-readable program code, to cause the processor device 48 to carry out the steps described herein. Thus, the computer-readable program code can comprise software instructions for implementing the functionality of the examples described herein when executed on the processor device 48. The processor device 48, in conjunction with the proxy process 16-1 in the volatile memory 56, may serve as a controller, or control system, for the computing device 46 that is to implement the functionality described herein. An operator may also be able to enter one or more configuration commands through a keyboard (not illustrated), a pointing device such as a mouse (not illustrated), or a touch-sensitive surface such as a display device. Such input devices may be connected to the processor device 48 through an input device interface 64 that is coupled to the system bus 52 but can be connected by other interfaces such as a parallel port, an Institute of Electrical and Electronic Engineers (IEEE) 1394 serial port, a Universal Serial Bus (USB) port, an IR interface, and the like. The computing device 46 may also include a communications interface 66, such as an Ethernet transceiver and/or a Wi-Fi transceiver, or the like, suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
determining a plurality of request latencies for a service process by, for each of a plurality of iterations:
receiving, by a proxy process, a request destined for the service process;
determining, by the proxy process, that a state of a first circuit breaker associated with the service process is a closed state such that the request can be sent to the service process;
sending, by the proxy process, the request to the service process;
storing, by the proxy process, a request latency of the plurality of request latencies in a data structure, wherein the request latency is representative of a period of time that elapsed between sending the request to the service process and determining that the service process has generated a response to the request; and
responsive to determining, based on the data structure, that an unfavorable request latency condition exists, setting the state of the first circuit breaker to an opened state, such that subsequent requests received by the proxy process cannot be sent to the service process.

2. The method of claim 1, further comprising:
prior to determining that the state of the first circuit breaker is the closed state, determining, by the proxy process, that the first circuit breaker is associated with the service process.

3. The method of claim 1, further comprising:
subsequent to setting the state of the first circuit breaker to the opened state, receiving, by the proxy process, a subsequent request from a requestor, the subsequent request destined for the service process; and
responsive to determining, by the proxy process, that the state of the first circuit breaker associated with the service process is the opened state, sending, by the proxy process, a request rejected indication to the requestor, and inhibiting sending the subsequent request to the service process.

4. The method of claim 1, wherein determining, based on the data structure, that the unfavorable request latency condition exists further comprises:
accessing, by the proxy process, the plurality of request latencies;
determining, by the proxy process, a calculated request latency based on one or more of the plurality of request latencies; and
determining that the calculated request latency is indicative of the unfavorable request latency condition.

5. The method of claim 4, wherein the calculated request latency is an average request latency, and wherein determining that the calculated request latency is indicative of the unfavorable request latency condition comprises determining that the average request latency exceeds a threshold latency value.

6. The method of claim 1, wherein determining, based on the data structure, that the unfavorable request latency condition exists further comprises:
accessing, by the proxy process, the plurality of request latencies;
determining, for each of one or more percentiles of the plurality of request latencies, a corresponding request latency value; and
determining that a corresponding request latency value of at least one of the one or more percentiles exceeds a threshold latency value.

7. The method of claim 1, further comprising:
receiving, by the service process, the request;
based on the request, sending an upstream request to an upstream service process;
receiving, by the service process from the upstream service process, an upstream service response to the upstream request; and
generating, by the service process, the response based on the upstream service response.

8. The method of claim 1, wherein the service process services requests directed to a plurality of different uniform resource locator (URL) paths, and wherein each respective URL path of the plurality of different URL paths has a corresponding circuit breaker indicator indicating whether the respective URL path has a corresponding circuit breaker, wherein at least one of the URL paths of the plurality of different URL paths has a corresponding circuit breaker and wherein at least another of the URL paths of the plurality of different URL paths does not have a corresponding circuit breaker.

9. The method of claim 8, further comprising:
determining, by the proxy process, that a request of the plurality of requests was directed to a particular URL path of the plurality of different URL paths;
determining, by the proxy process, that the corresponding circuit breaker indicator of the particular URL path indicates that the particular path has a corresponding circuit breaker; AND
determining, by the proxy process, that the corresponding circuit breaker of the particular URL path is the first circuit breaker.

10. The method of claim 8, wherein at least two URL paths have corresponding circuit breakers, and wherein the corresponding circuit breakers of the at least two URL paths have different unfavorable request latency conditions.

11. The method of claim 10, further comprising:
periodically, by the proxy process:
analyzing first URL path request latencies determined for a plurality of previous requests destined for the service process via a first URL path of the at least two URL paths;
based on the first URL path request latencies, determining to one of: set the state of the first circuit breaker that corresponds to the first URL path to the opened state or keep the state of the first circuit breaker that corresponds to the first URL path as the closed state;
analyzing second URL path request latencies determined for a plurality of previous requests destined for the service process via a second URL path of the at least two URL paths; and
based on the second URL path request latencies, determining to one of: set the state of a second circuit breaker that corresponds to the second URL path to the opened state or keep the state of the second circuit breaker that corresponds to the second URL path as the closed state.

12. The method of claim 1, further comprising:
subsequent to setting the state of the first circuit breaker to the opened state, determining, by the proxy process, that a predetermined period of time has elapsed; and
in response to determining that the predetermined period of time has elapsed, setting the state of the first circuit breaker to the closed state such that a subsequent request received by the proxy process can be sent to the service process.

13. A computing device, comprising:
a memory; and
one or more processor devices coupled to the memory operable to:
determine a plurality of request latencies for a service process by, for each of a plurality of iterations:
receiving, by a proxy process, a request destined for the service process;
determining, by the proxy process, that a state of a first circuit breaker associated with the service process is a closed state such that the request can be sent to the service process;
sending, by the proxy process, the request to the service process; and
storing, by the proxy process, a request latency of the plurality of request latencies in a data structure, wherein the request latency is representative of a period of time that elapsed between sending the request to the service process and determining that the service process has generated a response to the request; and
responsive to determining, based on the data structure, that an unfavorable request latency condition exists, set the state of the first circuit breaker to an opened state, such that subsequent requests received by the proxy process cannot be sent to the service process.

14. The computing device of claim 13, wherein to determine, based on the data structure, that the unfavorable request latency condition exists, the one or more processor devices are further operable to:
access, by the proxy process, the plurality of request latencies;
determine, by the proxy process, a calculated request latency based on one or more of the plurality of request latencies; and
determine that the calculated request latency is indicative of the unfavorable request latency condition.

15. The computing device of claim 14, wherein the calculated request latency is an average request latency, and wherein to determine that the calculated request latency is indicative of the unfavorable request latency condition, the one or more processor devices are further operable to determine that the average request latency exceeds a threshold latency value.

16. The computing device of claim 13, wherein the service process services requests directed to a plurality of different uniform resource locator (URL) paths, and wherein each respective URL path of the plurality of different URL paths has a corresponding circuit breaker indicator indicating whether the respective URL path has a corresponding circuit breaker, wherein at least one of the URL paths of the plurality of different URL paths has a corresponding circuit breaker and wherein at least another of the URL paths of the plurality of different URL paths does not have a corresponding circuit breaker.

17. A non-transitory computer-readable storage medium that includes executable instructions operable to cause one or more processor devices to:
determine a plurality of request latencies for a service process by, for each of a plurality of iterations:
receiving, by a proxy process, a request destined for the service process;
determining, by the proxy process, that a state of a first circuit breaker associated with the service process is a closed state such that the request can be sent to the service process;
sending, by the proxy process, the request to the service process; and
storing, by the proxy process, a request latency of the plurality of request latencies in a data structure, wherein the request latency is representative of a period of time that elapsed between sending the request to the service process and determining that the service process has generated a response to the request; and
responsive to determining, based on the data structure, that an unfavorable request latency condition exists, set the state of the first circuit breaker to an opened state, such that subsequent requests received by the proxy process cannot be sent to the service process.

18. The non-transitory computer-readable storage medium of claim 17, wherein to determine, based on the data structure, that the unfavorable request latency condition exists, the instructions are further operable to cause the one or more processor devices to:
access, by the proxy process, the plurality of request latencies;
determine, by the proxy process, a calculated request latency based on one or more of the plurality of request latencies; and
determine that the calculated request latency is indicative of the unfavorable request latency condition.

19. The non-transitory computer-readable storage medium of claim 18, wherein the calculated request latency is an average request latency, and wherein to determine that the calculated request latency is indicative of the unfavorable request latency condition, the instructions are further operable to cause the one or more processor devices to determine that the average request latency exceeds a threshold latency value.

20. The non-transitory computer-readable storage medium of claim 17, wherein the service process services requests directed to a plurality of different uniform resource locator (URL) paths, and wherein each respective URL path of the plurality of different URL paths has a corresponding circuit breaker indicator indicating whether the respective URL path has a corresponding circuit breaker, wherein at least one of the URL paths of the plurality of different URL paths has a corresponding circuit breaker and wherein at least another of the URL paths of the plurality of different URL paths does not have a corresponding circuit breaker.
